(19) United States
(12) Patent Application Publication
(10) Pub. No.: US 2014/0241975 A1
(43) Pub. Date: Aug. 28, 2014

(54) Process for the Production of Graphene Nanoribbons

(71) Applicants: Universitat Munster, Munchen (DE); Max Planck Gesellschaft Zur Forderung Der Wissenschaften E.V. Westfallsche Wilhelms, (unknown)

(72) Inventors: Dingyong Zhong, Munster (DE); Lifeng Chi, Munster (DE); Helmut Zacharias, Havixbeck (DE); Harald Fuchs, Munster (DE); Klaus Mullen, Koln (DE); Xinliang Feng, Mainz (DE)

(21) Appl. No.: 14/347,240

(22) PCT Filed: Sep. 27, 2012
(86) PCT No.: PCT/EP2012/069130

§ 371 Date: Mar. 25, 2014

(30) Foreign Application Priority Data
Sep. 30, 2011 (DE) 10 2011 054 103.9

(51) Int. Cl. C01B 31/04

(52) U.S. Cl. CPC C01B 31/0446
USPC 423/448

(57) ABSTRACT

The invention refers to a process for the production of graphene nanoribbons in the presence of an anisotropic metal surface which induces a spatial orientation of the nanoribbons.

The present invention relates to the field of graphene nanoribbons (GNR). Graphene nanoribbons are quasi one dimensional molecules which may achieve lengths of several dozen nanometers. Such graphene nanoribbons, which are, among others, described in Cai et al. Nature 466, 470 (2010), have a great potential for future electronic circuits, for example.

The previously available processes for the production of graphene nanoribbons, however, are disadvantages in the fact that it often affords great difficulties, if possible at all, to produce the graphene nanoribbons in a spatially defined and aligned orientation.

Thus, it is an objective to develop a process for the production of graphene nanoribbons which allows for a higher precision in adjusting the spatial orientation of the resulting nanoribbons,

This objective is solved by a process according to claim 1 of the present invention. Accordingly, a process for the production of graphene nanoribbons is provided, comprising the step of:
a) Heating an appropriate precursor material in vacuum in the presence of an anisotropic metal surface of a metal with a redox potential of ≧−0.5 V.

Surprisingly it was found that the spatial orientation of the graphene nanoribbons may be adjusted by this procedure at least partially or even extensively, depending on the application in question. In most cases aligns itself towards the anisotropy of the metal surface; thus, it is assumed (whilst not wishing to be bound by theory) that the anisotropy of the metal surface directs the orientation of the graphene nanoribbons to a great extent.

In the sense of the present invention, the term “graphene nanoribbons” refers in particular to molecules which may develop one dimensional, covalently bound graphene layers having geometrically sharp and well-defined boundaries on a molecular scale, for example linear or zig-zag structures.

In the sense of the present invention, the terra “anisotropic metal surface” means in particular that stepped single crystal surfaces, preferably those of a high indexing of e.g. (775), (788), are employed.

In the sense of the present invention, the term “redox potential” means in particular the potential of a metal (Mⁿ⁺n e⁻=>M) of the electrochemical series (standard potential at 25° C.: 101.3 kPa; pH=0; ion activities=1).

According to a preferred embodiment of he present invention, the metal is selected from the group consisting of Au, Ag, Cu, Fe, Co, Ni, Pd, Pt, Ir, Ru, Rh or mixtures thereof. These metals have proved themselves in practice.

According to a preferred embodiment of the present invention, the anisotropic metal surface is selected from the group consisting of [12, 11, 11], [11, 9, 9], [433], [755], [322], [11, 12, 12], (455], [577], [233], [788] and [775]-surfaces, in particular of gold and silver. It has been shown that the quality of the resulting graphene nanoribbons may likely be strongly improved in many cases.

According to a preferred embodiment of the present invention, the precursor material comprises an aromatic halide having at least two halogens and at least three aromatic rings. It has to be pointed out that the term “precursor material”, although written in singular form, does not imply that a mixture of materials must not be used; on the contrary, in practice this indeed is the case.

Preferred halides are chloride, bromide, iodide, particularly bromide and/or chloride.

Preferably, the precursor material comprises an aromatic halide in which two aromatic rings are bound by a single bond (analogous to the biphenyl). It has been shown that this strongly improves the propensity of being formed of the nanoribbons in many cases. Even more preferred are materials in which one or more halides are in a p-position relative to such a “biphenyl”-bond.

Preferably, the precursor material comprises an aromatic halide having at least one polynuclear aromatic system, wherein systems with two to four nuclei are preferred. Preferably, the precursor material consists of several such aromatic systems, which are preferably bound by carbon-carbon-single bonds (analogous to the biphenyl).

The precursor material may be composed in such a way that all carbon atoms form constituents of aromatic rings or ring systems; alternatively and equally preferred, however, are materials which consist of aliphatic carbons as well (preferably in the form of alkyl or haloalkyl residues). In this case, particularly preferred are annealed cyclohexane rings (analogous to the tetralin). It has turned out that the nanoribbons may be “broadened” in this way.

According to a preferred embodiment of the present invention, step a) is conducted under heating to a temperature of between ≧150° C. and ≦500° C.; this has proven particularly effective in practice.

According to a preferred embodiment of the present invention, step a) is performed at a pressure of between ≧1·10⁻¹¹ mbar and ≦5·10⁻⁴ mbar, preferably at a pressure of ≧1·10⁻¹° mbar, even more preferred of between ≧1·10⁻⁹ mbar and ≦5·10⁻¹⁰ mbar.

According to a preferred embodiment of he present invention, step is comprised of a step a1) and a2):
a1) Heating to a temperature of between ≧150° C. and ≦300° C.
a2) Heating to a temperature of between ≧300° C. and ≦500° C., preferably for a period of between ≧5 min and ≦20 min.

According to another preferred embodiment of the present invention, the process comprises the additional step a0):
a0) Cleaning of the anisotropic metal surface

which is performed prior to step a), respectively a1) or a2). Step a0) preferably comprises an argon sputtering step and/or an annealing step.

Thereby, the term “annealing” in the sense of the present invention means in particular that the surface is heated by the temperature used in step a) and/or a1).

Further details, features and advantages of the subject of the invention are set out in the subclaims and the pertinent drawings in which several embodiments of the process according to the invention are depicted by way of example. The drawings show in:

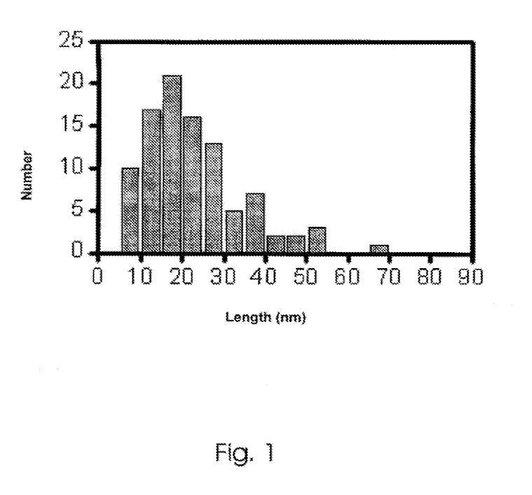

FIG. 1 a diagram of the length distribution of graphene nanoribbons produced according to a first embodiment of the invention (example I)

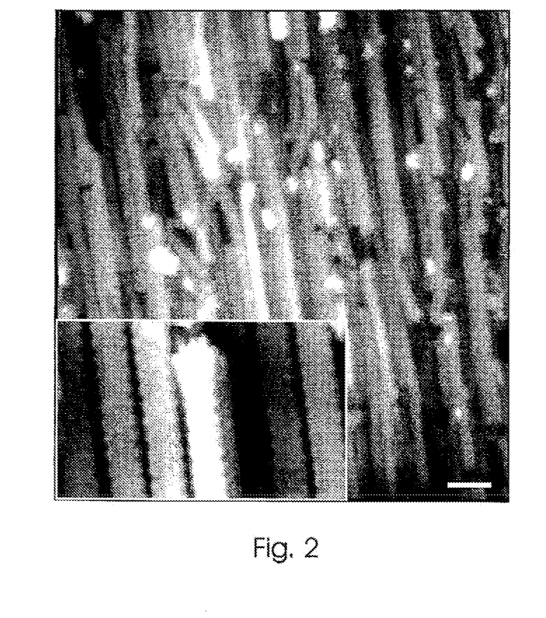

FIG. 2 a STM image of the graphene nanoribbons according to example I

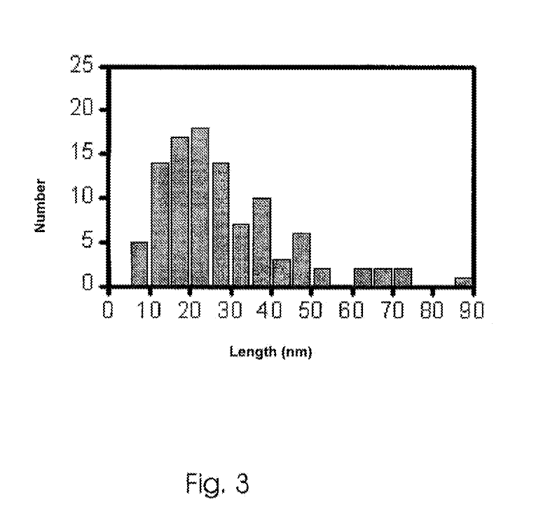

FIG. 3 a diagram of the length distribution of graphene nanoribbons produced according to a second embodiment of the invention (example II)

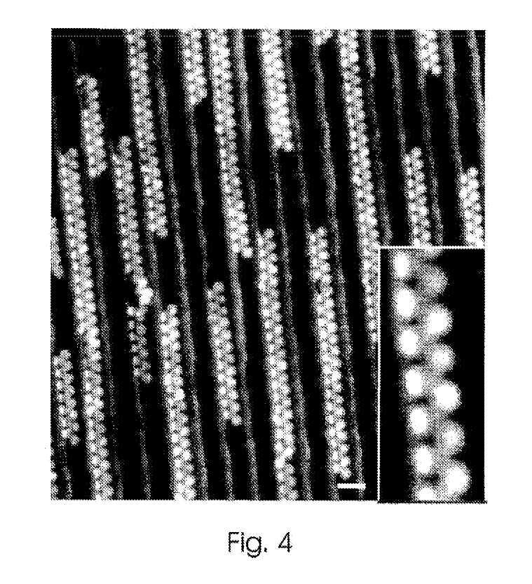

FIG. 4 a STM image of the graphene nanoribbons according to example II

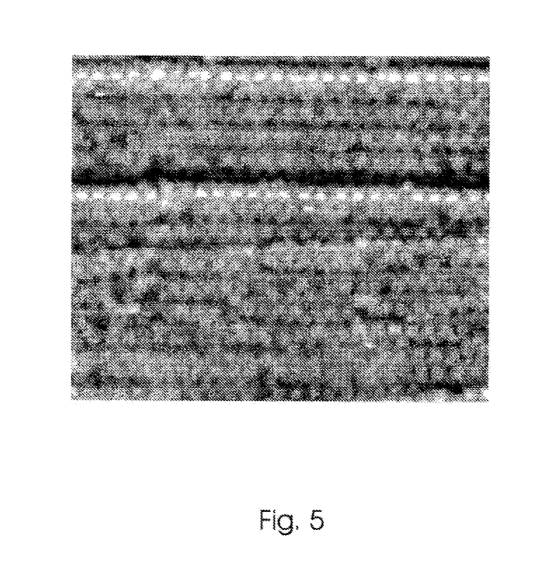

FIG. 5 a STM image of the graphene nanoribbons produced according to a third embodiment of the invention (example III).

The examples which follow are merely illustrative and should not be construed as limiting, and shall merely serve a better understanding of the invention.

### EXAMPLE I

### Production of Graphene Nanoribbons on a [788] Gold Surface

10,10′-Dibromo-9,9′-bianthryl was chosen as a precursor material for example I which has the following structure:

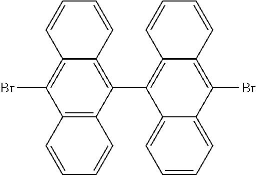 [SMILES: Brc1c2ccccc2c(-c2c3ccccc3c(Br)c3ccccc23)c2ccccc12]

First, the gold surface was cleaned by argon sputtering (several cycles of 1.7 to 0.9 kv) and annealing at approx. 500° C. Subsequently, the nanoribbons were produced in ultra vacuum (3·10⁻¹⁰ mbar) at surface temperatures of 162° C. to 200° C. which was followed by a cyclodehydrogenation at 317° C. Following this, the nanoribbons were examined by STM microscopy.

FIG. 1 shows the length distribution of the nanoribbons, FIG. 2 shows a STM image (magnified in a section). As is obvious from FIG. 2, the nanoribbons are spatially oriented almost uniformly, the average length being 22 nm (FIG. 1).

### EXAMPLE 2

### Production of Graphene Nanoribbons on a [788] Gold Surface

6,11-Dibromo-1,2,3,4-tetraphenyltriphenylene was chosen as a precursor material for example II, which has the following structure:

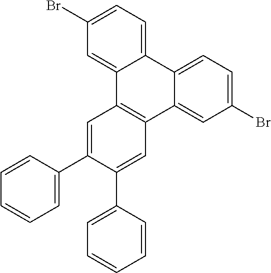 [SMILES: Brc1ccc2c3ccc(Br)cc3c3cc(-c4ccccc4)c(-c4ccccc4)cc3c2c1]

The production of the nanoribbons corresponded to example I. FIG. 3 shows the length distribution of the nanoribbons, FIG. 4 is a STM image (magnified in a section). As is obvious from FIG. 4, the nanoribbons are spatially oriented almost uniformly, the average length being 28 nm (FIG. 3).

### EXAMPLE III

### Production of Graphene Nanoribbons on a [775] Silver Surface

The same precursor material as in example II was used for example III.

First, the silver surface was cleaned by argon sputtering (several cycles of 1.7 to 0.9 kv) and annealing at approx. 500° C. Subsequently, the nanoribbons were produced in ultra vacuum 3·10⁻¹⁰ mbar) at surface temperatures of 162° C. to 200° C., which was followed by a cyclodehydrogenation at 320° C. Finally, the nanoribbons were examined by STM microscopy.

FIG. 5 shows a STM image of the resulting nanoribbons; here again, the resulting uniform orientation is clearly identifiable.

The individual combinations of the constituents and the features of the already mentioned embodiments are by way of example; an exchange and substitution of these teachings with other teachings, which are contained in this publication, and with the cited publications is explicitly contemplated as well. The cited publications are incorporated herein by citation. A person of skill in the art will recognize that variations, modifications and other embodiments than the ones described herein may be made without departing from the spirit and scope of the invention. Accordingly, the above description is exemplary only and not to be construed as limiting. The word “comprising” as used in the claims does not preclude other constituents or steps. The indefinite article “a/an” does not exclude the plural meaning. The mere fact that certain measures are recited in mutually different claims does not indicate that a combination of these measures cannot be used to advantage. The scope of the invention is defined by the following claims and the pertinent equivalents.

What is claimed is:

1. A process for the production of graphene nanoribbons comprising the step of:
a) heating an appropriate precursor material in vacuum in the presence of an anisotropic metal surface of a metal with a redox potential of ≧−0.5 V.

2. The process of claim 1, wherein the metal is selected from the group consisting of Au, Ag, Cu, Fe, Co, Ni, Pd, Pt, Ir, Ru, Rh or mixtures thereof.

3. The process of claim 1, wherein the anisotropic metal surface is selected from the group consisting of [12, 11, 11], [11, 9, 9], [433], (755], [322], [11, 12, 12], [455], [577], [233], [788] and [775]-surfaces.

4. The process of claim 1, wherein the precursor material comprises an aromatic halide having at least two halogens and at least three aromatic rings.

5. The process of claim 1, wherein step a) is conducted under heating to a temperature of between ≧150° C. and ≦580° C.

6. The process of claim 1, wherein step a) is performed at a pressure of between ≧1·10⁻¹¹ mbar and ≦5·10⁻⁴ mbar.

7. The process of claim 1, wherein step a) is comprised of a step a1) and a2):
a1) Heating to a temperature of between ≧150° C. and ≦300° C.
a2) Heating to a temperature of between ≧300° C. and ≦500° C.

8. The process of claim 1, additionally comprising a step a0):
a0) Cleaning of the anisotropic metal surface
which is performed prior to step a), respectively a1) or a2).

9. The process of claim 8, wherein Step a0) comprises an argon sputtering step and/or an annealing step.
